(19) United States
(12) Patent Application Publication
(10) Pub. No.: US 2006/0113737 A1
(43) Pub. Date: Jun. 1, 2006

(54) Toddler walking aid system and device

(76) Inventors: Julie L. Austin, Southfield, MI (US); Brett F. Austin, Southfield, MI (US)

Correspondence Address: Steven Thrasher, 391 Sandhill Dr., Richardson, TX, 75080, US

(21) Appl. No.: 11/331,802

(22) Filed: Jan. 13, 2006

Related U.S. Application Data
(63) Continuation-in-part of application No. 10/668,090, filed on Sep. 19, 2003.

(51) Int. Cl. B62B 7/06

(52) U.S. Cl. 280/35

(57) ABSTRACT

The invention is a toddler walking aid system and device that allows a toddler to walk along the side of a stroller or baby carriage without falling. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### RELATED APPLICATION

The invention is related to and claims priority from co-pending U.S. patent application Ser. No. 10/668,090 invented by Julie Austin and Bret Austin, entitled TODDLER WALKING AID SYSTEM AND DEVICE, filed Sep. 19, 2003.

### TECHNICAL FIELD

The invention relates to strollers, and, more particularly, the invention relates to strollers for toddlers.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art

Discussion

Adults typically use a child stroller to carry a seated toddler. Strollers are used because a toddler has not developed the skill of walking on their own or because a toddler is unable to walk for an extended distance. A toddler that has not developed the skill of walking is dependent on an adult or other supporting object for assisting with coordination and balance.

Known strollers and carriages include those disclosed in U.S. Pat. Nos. 3,485,507; 3,336,039; 4,946,180; 4,191,397; 5,625,923; 5,022,669; and 6,070,889, the contents of which are incorporated by reference herein in their entirety.

Frequently, toddlers become restless when seated for long periods of time. In some instances, toddlers cry and scream and may try to climb out of the stroller. In more severe instances, toddlers injure themselves while trying to climb out of the stroller or cause the stroller to turn over. If the child could egress from the stroller and have a physiological and physical assistance, then the parent or guardian could allow the child to walk along side the stroller. The stroller disclosed in U.S. Pat. No. 6,070,889 attempts to address this problem with rigidly affixed articulating arms. However, since all children are not the same height, and since it is unpractical to think that all strollers and carriages will be adapted with such a device, the suggested solution is inadequate. Accordingly, it is advantageous to provide toddlers walking support in addition to a stroller seat.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a toddler walking aid system;

FIG. 1b (prior art) illustrates a prior-art child walker, as FIG. 1c illustrates a support member coupled to a prior-art child walker;

FIG. 2 illustrates a top view of a toddler walking aid device;

FIG. 3 illustrates a side view of a toddler walking aid system; and

FIG. 4 illustrates a side view of a toddler walking aid device having a flexible joint.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for— functioning—” or “step for— functioning—” in the Claims section.

Discussion of the Figures

The invention can be characterized as toddler walking systems and devices that assist a toddler with developing skills associated with walking. In one embodiment, the toddler walking aid is a system comprising a supporting member that is adapted to couple to a child stroller portion via a coupling means. In an alternative embodiment, the toddler walking aid is a device comprising a supporting member that is adapted to couple to a stroller portion via a coupling means having a joint and a fastening means. In yet another embodiment, the toddler walking aid is a system comprises a supporting member adapted to attach to stroller portion via a coupling means having a joint enabled to articulate the supporting member into a plurality of predefined positions or, through a range of motion to any position reachable.

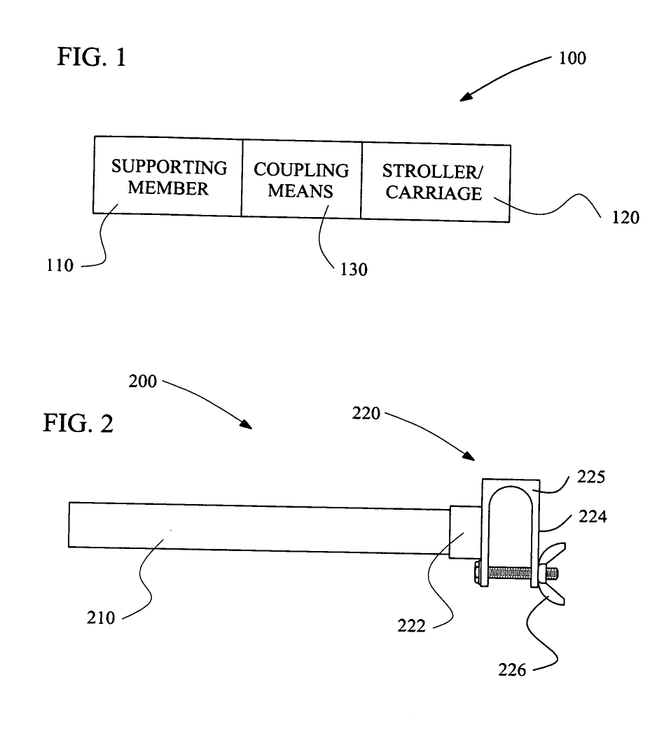

Features and advantages of the invention can be better understood by reviewing FIG. 1, which illustrates a toddler walking aid system 100. The toddler walking aid system 100 comprises a rigid supporting member 110, a stroller portion 120, and a coupling means adapted to couple the supporting member 110 to the stroller portion 120.

In a preferred embodiment, the supporting member 100 is a foam-coated pipe that is coupled to a side portion of a stroller pipe 120 via a bracket. In an alternative embodiment, the supporting member 110 is a foam-coated rod that is coupled via a clip to a stroller armrest 120. In yet another alternative embodiment, the supporting member 110 is a rigid foam tube that is coupled to a clip that is attachable to a leg of a stroller 120 such that it forms a cross-bar when attached to the stroller.

Accordingly the stroller portion 120 may be any portion of a child stroller such as a pipe, an armrest, a leg, a canopy, or handle, for example. A child stroller is easily identifiable by ordinary persons, and particularly by those of ordinary skill in the stroller arts by the fact that it comprises a small seat located low to the ground—usually no more than a foot off the ground, and more often are nor more than four inches or no more than six inches off the ground. In addition, child seats are typically less than one foot in width. Other characteristics of child strollers are that they are typically made of a light material, such as hollow aluminum or plastic, and sit low enough to allow an adult to push the stroller and the child seated in it from behind. Thus, a child stroller has handles that are typically no more than three feet high, but may also be as low at two feet high, and are generally located behind the low-sitting child seat(s). Federal Law provides specifications and standards for child strollers, such specifications being readily apparent and known to those of skill in the art, and these standards are incorporated by referenced herein. In a preferred embodiment, with reference to FIGS. 1b(prior art) and 1c, the stroller 10 includes a child seat 12, a frame 20 that supports the seat 12. The frame 20 has ground-engaging wheels 14 from FIG. 1b one can see one manner of positioning the child seat 12 within the frame 20. The frame 20 preferably has at least two generally vertical frame members 22, 24 being generally parallel, and at least two generally horizontal frame members 26, 28 also being generally parallel.

A stroller portion 120 may comprise metal, plastic, or wood, for example that is adapted to receive a supporting member. In some instances, a stroller portion 120 may itself be removably attachable to a stroller. In other instances, a stroller portion 120 is integrally formed with and indistinguishable from a stroller body.

The supporting member 110 is any solid or hollow member, such as a pipe, rod, shaft, or stick, for example that allows a child to support himself at a comfortable height, a comfortable distance such as 18 inches from the stroller to which it is attached. Thus, the rigid supporting member 110 is able to support the weight of a child, and comprises at least a section of no more than two inches in circumference and is no less than twelve inches in length. In addition, when mounted to a stroller, the support member 110 is generally a cross-bar that a toddler or other child can grasp about chest-high.

In a preferred embodiment, the supporting member 110 is coated with a soft material, such as foam, rubber, or cork, for example that forms a grip. The grip may have indentations, ridges, or raised shapes, such as animals, toys, or geometric shapes, for example, for assisting a toddler to hold on to the supporting member 110 with one's hands.

Of course, it should be understood that the stroller portion may comprise an optional element of the invention, as, of course, the invention in some embodiments could be manufactured, shipped, and sold apart from a stroller.

The coupling means 130 is any device or group of devices that allow means that supporting member 110 to rigidly attach to the stroller portion 120. In a preferred embodiment, the coupling means 130 comprises a bracket that is adapted to removably attach to a stroller portion via a wing nut, clamp, or other grasping mechanism. In an alternative embodiment, the coupling means 130 may comprises a clip. In yet another embodiment, the coupling means 130 may be integrally formed within the stroller portion 120.

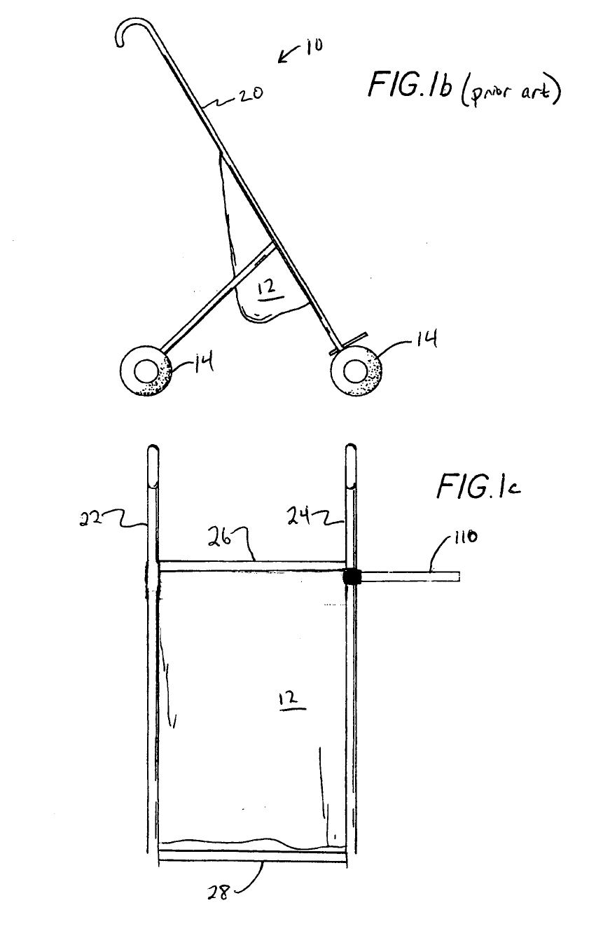

FIG. 2 illustrates a top view of a toddler walking aid device 200. The toddler walking aid device 200 generally comprises a supporting member 210 and a coupling means 220. In a preferred embodiment, the coupling means 220 comprises a joint 222 and a fastening means 224 shown here as a clamping portion bracket 225 and nut-and-bolt grasping member 226. Thus, the user-articulatable grasping member 226 couples to the clamping portion (here, via threaded holes), such that when the grasping member is in a first position, the grasping member 226 is not rigidly clampable to a stroller and the coupling means is detachable from the frame, and when the grasping member 226 is in a second position, the coupling means is in a position that allows it to be rigidly affixed to the frame of a stroller.

In one embodiment, the supporting member 210 screws into the joint 222, and the joint is integral with a clamp 225. In an alternative embodiment, the coupling means 222 may also comprise a fastening means 224, which may couple to a matched pocket or receiving member of a child stroller.

Preferably, the joint 222 is rigid, but may also be flexibly articulated into a plurality of positions, some of which may be predefined. In an alternative embodiment, the joint 222 may be adapted to only articulate into a limited number of positions (as is known in the art, this is achievable with gears). In yet another embodiment, the joint 222 may be rigid and fixed at a specific angular position.

The fastening means 224 is a coupling means, and is more generally any means that secures the supporting member 210 to a stroller portion, such as a clamp, bracket, clip, or screw, for example. In the present preferred embodiment, the fastening means 224 comprises a U-shaped bracket 225 that is adapted to attach to a stroller portion and is tightened via the nut-and-bolt 226.

In an alternative embodiment, the fastening means 224 is a clip that is adapted to removably attach to a stroller portion. In one embodiment, the fastening means 224 is a leveraged pressure-joint, which is well known in the mechanical arts.

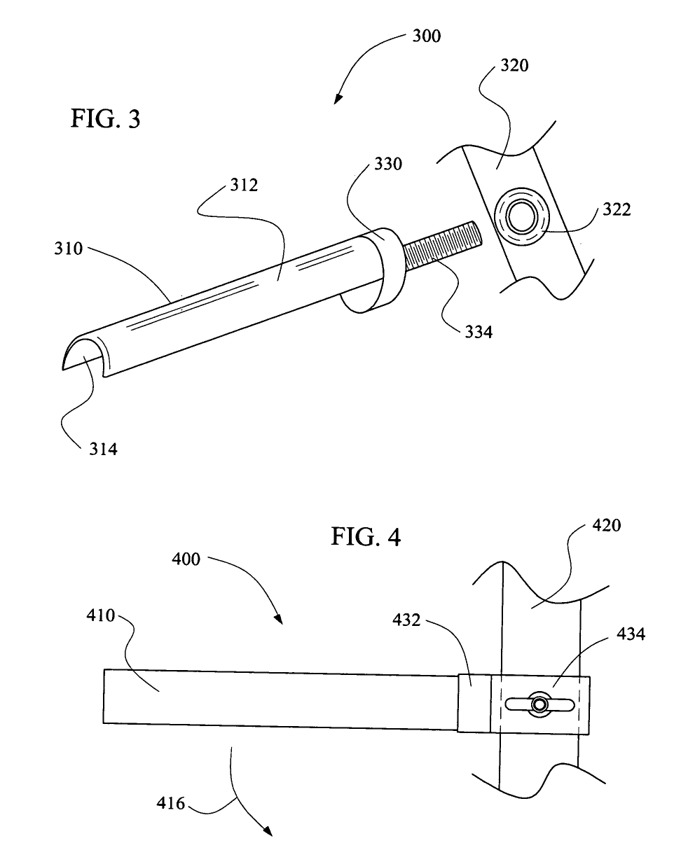

FIG. 3 illustrates an alternative preferred embodiment of a toddler walking aid device 300. The walking aid device 300 comprises a supporting member 310 that is generally half-tubular (a cylinder cut length-wise) in shape comprising a top portion 312 preferably being coated with a foam-like grip and an open bottom portion 314, thus forming a half-moon shaped cavity.

Provided is a coupling means 330 that removably couples the supporting member 310 to the frame 320. The coupling means 330 comprises a male attaching portion 334 shaped to accommodate the interior of a female coupling member 322. In FIG. 3, the coupling means 330 comprises a threaded fastening means/male attaching portion 334 that is removably attached (as is readily apparent to those of skill in the mechanical arts) to a stroller at what is illustrated in FIG. 3 as a generally vertical pipe portion 320. The vertical pipe portion 320 comprises a threaded plastic hole joint 322, which also may function as a washer in the configuration shown. Preferably, when attached, the fastening means 334 is screwed into the threaded hole of the threaded plastic joint 322. Furthermore, when the walking aid 300 is stowed, the fastening means 334 is detached from the stroller pipe portion 320 such that the supporting member's open bottom portion 314 “snaps” onto a corresponding form-fitted portion of the stroller as is readily understood by those of ordinary skill in the art. Of course, it is understood to those of skill in the art that the shown coupling means is illustrative, and other coupling means apparent to those of skill in the art are incorporated without departing from the scope of the invention.

FIG. 4 illustrates a preferred embodiment of a walking aid system 400 having a rotating and flexible joint 432. In particular, FIG. 4 shows an embodiment similar to that of FIG. 2 attached to a stroller. The joint is radially flexible as illustrated by the directional arrow 416. The joint 432 has a positional memory and may be articulated into a plurality of positions such that it accommodates a toddler's ever-changing height. In addition, the joint 432 may be positioned to aid in the stowage of the supporting member 410. In one embodiment, a fastening means 434 is fastened to a generally tubular stroller portion 420 and the supporting means is integral with the fastening means 434. In an alternative embodiment, the supporting member 410 may be stowed by securing the supporting member 410 to a stroller portion 420 via a string, clip, or strip of Velcro, for example.

Of course, it would be readily apparent to those of ordinary skill in the art that an alternative embodiment may include embodying the supporting member as a telescoping walking aid system. Furthermore, it is also apparent that the components of the walking aid system may be made of different materials other than those described.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A toddler walking system that supports a toddler comprising:
a child stroller comprising
a child seat,
a frame supporting the seat, the frame having ground-engaging wheels and the child seat positioned within the frame,
the frame having at least two generally vertical frame members being generally parallel;
the frame also having at least two generally horizontal frame members being generally parallel;
a rigid supporting member able to support the weight of a child, the supporting member comprising at least a section of no more than two inches in circumference and the member being no less than twelve inches in length; and
a coupling means that removably manually couples the supporting member to the frame, the coupling means comprising
a clamping portion that is generally U-shaped and has an interior, such that the clamping portion interior accommodates a portion of the frame, and
a user-articulatable grasping member coupled to the clamping portion, such that when the grasping member is in a first position, the coupling means is detachable from the frame, and when the grasping member is in a second position, the coupling means is rigidly affixed to the frame.

2. The walking system of claim 1 wherein the supporting member comprises a foam covering.

3. The walking aid device of claim 1 wherein the fastening means comprises a clip.

4. The walking aid device of claim 1 wherein the fastening comprises a bracket.

5. The walking aid device of claim 1 wherein the fastening means comprises a threaded member.

6. The walking aid device of claim 1 wherein the supporting member is generally cylindrical.

7. A toddler walking system that supports a toddler comprising:
a child stroller comprising
a child seat,
a frame supporting the seat, the frame having ground-engaging wheels and the child seat positioned within the frame,
the frame having at least one generally vertical frame member,
the frame having a female coupling means;
a rigid supporting member able to support the weight of a child, the supporting member comprising at least a section of no more than two inches in circumference and the member being no less than twelve inches in length; and
a coupling means that removably couples the supporting member to the frame, the coupling means comprising a male attaching portion shaped to accommodate the interior of the female coupling member.

8. The system of claim 7 wherein the male attaching portion is threaded.
